(19) United States
(12) Patent Application Publication
(10) Pub. No.: US 2021/0359351 A1
(43) Pub. Date: Nov. 18, 2021

(54) LITHIUM-ION BATTERY CELL RECYCLING PROCESS

(71) Applicant: East Penn Manufacturing Co., Lyon Station, PA (US)

(72) Inventors: John A. Barkanic, Coopersburg, PA (US); Gennady Dantsin, Allentown, PA (US)

(73) Assignee: East Penn Manufacturing Co., Lyon Station, PA (US)

(21) Appl. No.: 17/314,253

(22) Filed: May 7, 2021

Related U.S. Application Data
(60) Provisional application No. 63/024,896, filed on May 14, 2020.

(51) Int. Cl. H01M 10/54

(52) U.S. Cl. CPC H01M 10/54

(57) ABSTRACT

A method of recycling a lithium-ion battery, having a lithium-based cathode material deposited on a metallic cathode collector and an anode material deposited on a metallic anode collector, includes the steps of isolating an individual battery cell from a lithium-ion battery, and mechanically segmenting the battery cell into a plurality of pieces. The resulting segments are heated in an inert, dry atmosphere to a temperature below the melting point of the metallic components of the cell. Once cooled, the lithium-based cathode material is separated from the cathode collector in a first separation operation. A subsequent second separation operation separates the cathode collector from the anode collector.

### CROSS-REFERENCE TO RELATED APPLICATION

This application claims priority under 35 U.S.C. § 119 to U.S. Provisional Patent Application No. 63/024,896, filed May 14, 2020.

### FIELD OF THE INVENTION

The present disclosure relates to a process for recycling energy storage devices, and more particularly, to a process for reclaiming the valuable materials of one or more lithium-ion battery cells.

### BACKGROUND

The ever-increasing energy requirements of portable electronic devices, such as personal computing devices and electric or hybrid automobiles, have been a driving force behind the development of battery technology in the modern era. State-of-the-art electronic devices place significant demands on batteries both in output as well as weight, requiring substantial current delivery while being lightweight and compact enough to avoid hindering the portability of the host device.

While rechargeable nickel-based batteries (e.g., NiCad and NiMH) had gained popularity, lithium-ion batteries have more recently emerged as the preferred choice for portable electronics equipment and vehicles. Given their vast use both today and into the foreseeable future, once their usable life, or the useable life of the device in which they are utilized, has been reached, the handling of such large quantities of used batteries will pose a significant technical challenge facing the industry.

In general, batteries contain toxic materials that are hazardous to our health and the environment if left in a landfill, in addition to being highly reactive in the case of a lithium-ion battery. Further, numerous components of the battery possess significant value if they can be suitably recovered and reused. If usable materials can be recovered from used batteries, less raw material needs to be extracted from the limited supplies in the ground, and emissions resulting from the systems used to both procure the materials, as well as transport them around the world, will be reduced.

For all of the above reasons, lithium-ion battery recycling appears to be a preferred solution. However, several factors contribute to making lithium-ion battery recycling more complicated compared to recycling processes for other battery types. For instance, lithium-ion batteries have a wider variety of materials in each cell. The active materials used in each cell, for example, typically take the form of a powder coated onto a metallic foil collector. These different materials must be separated from one another during recycling efforts.

While several lithium-ion battery recycling methods exist today, known methods thus far include one or more of undesirable results, or complex and/or expensive processing steps. For example, processes have been developed which utilize extreme heat in order to melt all of the valuable metals of the battery into an alloy or a combination of an alloy and a slag material. As a result, recovery of individual materials requires additional complex processing steps. Still other methods include the need to mechanically separate the components of the battery (e.g., manually separate an anode from a cathode) prior to subsequent material recovery processing, which is time and labor intensive, and thus expensive. Still other methods are not environmentally friendly, adding to the complexity of the process, such as those which utilize liquid water or steam, and/or those which result in the production of acidic gases, such as carbonic acid or other organic acids.

Accordingly, there is a need for a battery recycling processes suitable for lithium-ion batteries which is both efficient and environmentally friendly.

### SUMMARY

According to an embodiment of the present disclosure, a method for recycling a lithium-ion battery includes isolating individual battery cells from a lithium-ion battery pack containing a plurality of cells. One or more isolated cells may be segmented (e.g., mechanically cut), and heated in a dry, inert atmosphere to a temperature below the melting point of its metallic components (e.g., below the melting point of an aluminum foil cathode collector of the cell). After heating, the battery segments are cooled to room temperature or below for inducing interface stress or tension, stress fracturing, and/or cracking between an active cathode material (e.g., lithium oxide) and the cathode collector. Internal tension between the materials and/or fracturing or peeling of the active material from the collector material facilitates a subsequent step of mechanically separating the active material from the surface of the collector material. Once the active material is removed, a second separation step may be performed for separating the cathode collector from the anode collector.

### BRIEF DESCRIPTION OF THE DRAWINGS

The invention will now be described by way of example with reference to the accompanying figures, of which:

FIG. 1 is a perspective view of a simplified, partially-exposed lithium-ion battery cell useful for describing embodiments of the present disclosure;

FIG. 2 is a simplified process diagram outlining the steps of a lithium-ion battery recycling process according to the present disclosure;

FIG. 3 is a simplified schematic diagram of an exemplary system useful for performing a recycling process according to embodiments of the present disclosure;

FIG. 4 is a perspective view of a segment of a lithium-ion battery cell after heating and cooling steps have been performed according to embodiments of the present disclosure;

FIG. 5 is a process diagram outlining steps of a lithium-ion battery recycling process according to a preferred embodiment of the present disclosure;

FIG. 6 is an illustration of a photograph of a cathode collector and active cathode material after processing according to embodiments of the present disclosure;

FIG. 7 is an illustration of a scanning electron micrograph (SEM) of active cathode material removed using a process according to embodiments of the present disclosure; and

FIG. 8 is an illustration of a photograph of an anode collector after being separated from a cathode collector according to embodiments of the present disclosure.

### DETAILED DESCRIPTION OF THE EMBODIMENT(S)

Exemplary embodiments of the invention will be described hereinafter in detail with reference to the attached drawings, wherein like reference numerals refer to like elements. The invention may, however, be embodied in many different forms and should not be construed as being limited to the embodiments set forth herein; rather, these embodiments are provided so that the present disclosure will be thorough and complete, and will fully convey the concept of the disclosure to those skilled in the art.

The embodiments set forth in detail herein allow for the reclaiming of materials used in the fabrication of lithium-ion based battery cells. Embodiments process battery cells in an efficient and environmentally-friendly manner to recover, for example, lithium-containing cathode material, copper anode electrodes and aluminum cathode electrodes for the purpose of recycling, recovery and/or future reuse.

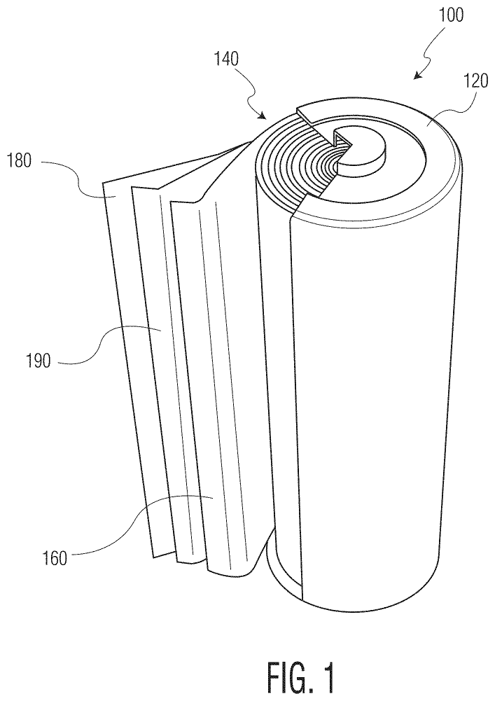

Referring generally to FIG. 1, a simplified view of a partially-exposed lithium-ion battery cell 100 is shown. The exemplary battery cell 100 includes a metallic casing 120 (e.g., a steel casing) containing a stack of sheets 140 spirally-wound therewithin. Generally, each stack includes three sheets which may be pressed together, including a positive electrode 160, a negative electrode 180 and a separator 190 arranged therebetween. Within the casing 120, the stack of sheets 140 may be submerged in an organic solvent (not shown) that acts as an electrolyte, such as a lithium hexafluorophosphate solution (e.g., 1 M LiPF₆) in a cyclic carbonate-based solvent mixture, for example ethylene carbonate in ethyl methyl carbonate.

In one exemplary configuration, the positive electrode 160 consists of a cathode collector of aluminum foil. An active cathode material, for example lithium mixed metal oxide or lithium cobalt oxide, is coated or otherwise deposited on the aluminum foil collector to form the positive electrode 160. A polymeric binder adhesive may be used to facilitate the attachment of the cathode material to the aluminum foil. Likewise, the negative electrode 180 may include an anode collector of copper foil, for example, with an anode material of carbon or graphite deposited or coated thereon. The separator 190 may comprise a thin sheet of plastic or other polymer, and is used to separate the positive electrode 160 and the negative electrode 180. The separator 190 may be perforated, allowing for the passage of ions therethrough during battery operation.

A recycling process according to embodiments of the present disclosure enables the removal and reclamation of the valuable active cathode material, while avoiding any unnecessary contamination thereof which would necessitate additional subsequent processing. Recovery of the respective cathode and anode collector materials is also enabled, as set forth in greater detail herein.

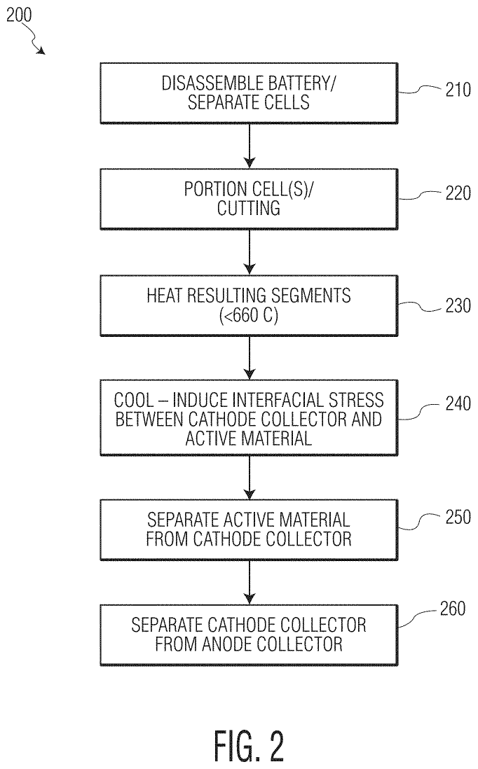

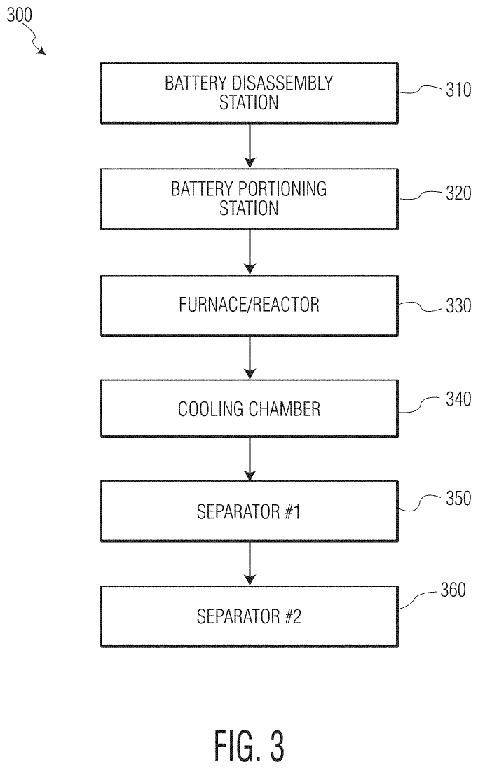

An exemplary recycling process according to embodiments of the present disclosure will be described in the context of a system useful for performing the same. Specifically, FIG. 2 illustrates a battery recycling process 200 according to embodiments of the present disclosure which may be performed by the simplified system 300 shown in FIG. 3. With reference to FIG. 3, it should be understood that each arrow appearing between the various components of the system 300 may represent either a manual carrying or moving step, in which an operator physically conveys batteries or segments thereof between each illustrated system component. Likewise, it should be understood that the arrows may represent steps of an at least partially automated process, wherein devices for locating (e.g., visual identification systems), moving/translating (e.g., gripping devices) and carrying (e.g., conveyor systems) the batteries or battery segments between system components may be utilized without departing from the scope of the present disclosure.

Referring again to FIGS. 2 and 3, unlike lead-acid batteries which have a relatively small number of large lead plates packaged together in a single plastic case, a typical lithium-ion battery pack may contain hundreds or even thousands of interconnected individual cells and accompanying control circuitry. Accordingly, a first step according to an embodiment of the present disclosure includes disassembling 210 a lithium-ion battery pack in order to isolate one or more battery cells (e.g., cell 100 of FIG. 1) from one another, as well as from other related control circuitry or interconnections present within the pack. This step may be performed in an automated manner for standardized battery packs, or may be performed manually at a disassembly station 310 of the recycling system 300, as shown in FIG. 3. Once isolated, the cell casing(s) may be removed, and the remaining internal components of one or more cells may be segmented or portioned 220 in a cutting operation performed at a portioning station 320. The portioning station 320 may comprise one or more cutting or chopping mechanisms used to reduce the battery cells into generally similarly-sized pieces of mixed copper foil coated with carbon anode material and aluminum foil coated with lithium cathode material.

In a subsequent step, the resulting battery cell segments are subject to a pyrolysis operation, whereby they are heated 230 by a high temperature reactor or furnace 330 (e.g., an electrical or chemical reactor). In order to enable the recovery of the metallic components of the battery in their current states, the temperature of the reactor 330 is established so as not to exceed the melting point of aluminum (i.e., less than 1,221° F. or 660° C.), and is preferably around 600 to 650° C. While the integrity of each of the desirable battery components is maintained at these temperatures, they have been found to be sufficient to degrade the typical adhesives used for securing the cathode material to the aluminum foil collector.

An interior of the reactor 330 may be supplied with an inert gas (e.g., nitrogen, argon or helium), for maintaining an inert atmosphere during the heating process. The inert atmosphere ensures that the cathode active material is maintained in a chemically unaltered physical state. The combustion or oxidation process chemistries are maintained at a minimum, thereby minimizing exothermic heat and unfavorable process temperature. Beyond amounts occurring naturally in the atmosphere, it is particularly critical that no steam, water or other contaminants be introduced into the reactor atmosphere during pyrolysis, thereby avoiding the creation of acidic gases as occurring in prior-art methods.

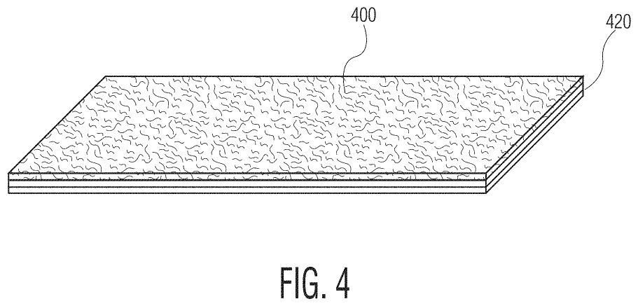

Upon exiting the reactor 330, the battery segments are cooled 240 in a controlled fashion to at least room temperature. This cooling operation may take place gradually in an open space with ambient atmospheric conditions, or may be enhanced by a supplemental cooling system including a cooling chamber 340. By controlling the rate at which the battery segments are cooled, the physical properties of the segments may be affected in a manner so as to improve the recycling process. Specifically, due to, for example, differing coefficients of thermal expansion of the battery materials, the heating and subsequent cooling steps 230, 240 are configured to introduce interface or interfacial stress between materials, and particularly between the active material and the cathode collector. These stresses may introduce defects between materials, such as fracture sites, or even result in the physical separation (e.g., peeling) of the active material from the collector material. For example, FIG. 4 shows a partial view of a battery segment wherein active cathode material 400 has begun to separate from the aluminum collector material 420 prior to any physical or mechanical separation operation being performed thereon.

Referring again to FIGS. 2 and 3, in further processing the lithium cathode material and aluminum foil substrate can be isolated or separated 250 using automated separation methods utilizing one or more first mechanical separation devices 350. Such separation methods may include, but are not limited to, subjecting the battery segments to vibrations or shaking, electromagnetic agitation, air currents, sieving, and the like. Once the active material has been sufficiently removed and recovered from the cathode collector, the intact and attached copper foil and aluminum foil collectors can now be efficiently separated 260 using a second separation device 360, such as an eddy current separator.

Beneficially, processing according to the embodiments of the present disclosure does not separate the graphite or carbon active material coating on the anode collector copper foil. With the graphite or carbon remaining on the anode collector, the copper foil is protected from the fields generated during eddy current separation. Accordingly, an advantage presented by the disclosed embodiments includes enabling the use of existing eddy current separation technologies to separate the aluminum cathode collector from the copper anode collector.

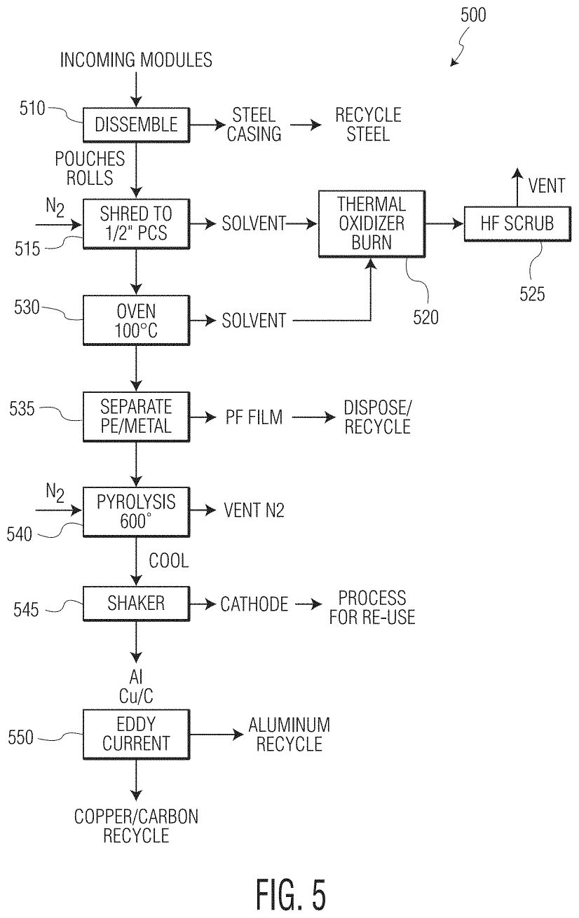

FIG. 5 provides a more detailed diagram of a recycling process 500 according to a preferred embodiment of the present disclosure. In a first step, one or more lithium ion battery cells are disassembled 510, and their casings removed for further recycling processing. The remaining wound cathode and electrode rolled sheets (see FIG. 1) are subject to a cutting or shredding operation 515, reducing their size to approximately one-half inch pieces. Solvent collected during this step may be subject to a thermal oxidization process 520 for decomposition and eventual venting to the atmosphere. The scrubbing 525 of hydrogen fluoride (HF) can be accomplished using either an aqueous caustic solution (i.e., sodium hydroxide in water) or a reactive solid scrubbing material. After sizing, the pieces may be subject to an initial heating step, wherein the material is heated 530 in an oven to a relatively low temperature of between 80 and 120° C., and preferably approximately 100° C. This low-temperature heating step facilitates the removal of a remainder of the solvent, which is likewise subject to the thermal oxidization process 520 for decomposition. Once heated, the separator material, for example polyethylene (PE) film, is separated 535 from between the metallic collector foils. The PE film can be separated using air jet separation, by way of example only. This method of segregating materials uses the density difference of the materials to achieve separation. Once removed, the film may either be discarded or subject to a further recycling operation.

The remaining adjoined cathode and anode collector pieces are then placed in a pyrolysis reactor and heated 540 to approximately 600-650° C. in an inert gas atmosphere of nitrogen (N₂), by way of example. In one exemplary process, the electrodes are exposed to a flowing nitrogen environment of approximately 150-170 standard cubic centimeter per minute (SCCM) during the heating process. In one particularly beneficial embodiment, the material is processed at 163 SCCM with N₂ gas at 643° C. for approximately 45 minutes. The pyrolyzed electrodes are then cooled to at least room temperature, after which they are subject to a mechanical separation process, for example, shaking 545 in order to free active cathode material in particle form from the collector foil. Recovered active cathode material may be subject to further processing for future reuse. The remaining cathode collector foil and attached anode collector foil are subject to further separation processing 550, such as being placed in an eddy current separator, by way of example only. The resulting separated aluminum foil and copper foil/carbon material may also be recycled.

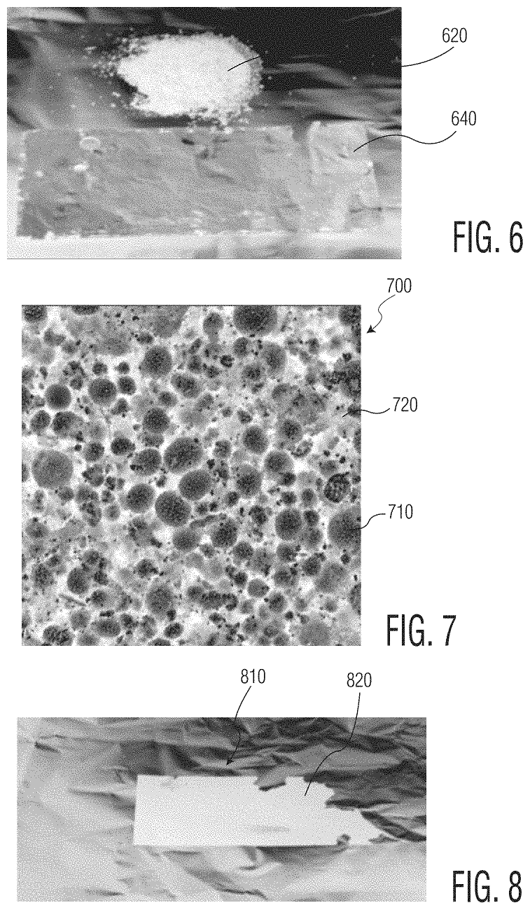

FIGS. 6-8 illustrate the results of the recycling process set forth in FIG. 5. Specifically, FIG. 6 illustrates active cathode material 620 after it has been mechanically separated from an aluminum current collector 640 using a process according to embodiments of the present disclosure. As shown, the cathode material 620 is separated in generally granular form, while the aluminum current collector is largely intact and suitable for further downstream recycling processing. FIG. 7 is a representation of a scanning electron micrograph (SEM) of removed active cathode material 700 (scale bar=30 μm) that has been separated from the aluminum current collector 640 shown in FIG. 6 during an inert gas pyrolysis process according to embodiments of the present disclosure. The active spherical lithium nickel manganese cobalt oxide cathode particles 710 (e.g., NMC111) have retained their original structure. The material 720 interspersed in the material 700 includes activated carbon and polymeric binder still intact in the powder. FIG. 8 is another post-processing illustration showing a copper foil anode electrode 810 with a carbon layer 820 still adhered thereto. As set forth above, by retaining the carbon layer on the anode collector foil, separation of the cathode collector and the anode collector is enabled via the use of an eddy current separator.

It should be understood that embodiments of the present disclosure beneficially do not require manual or physical separation of the anode collector foil from the cathode collector foil prior to the recovery of the active cathode material. As the anodes and cathodes are designed to be in close proximity of each other within a cell, a process suitable for use at large scale must handle both the anode and cathode simultaneously without an expensive initial separation. The above-described process presents a unique approach using pyrolysis of materials as a method of separating materials that here to for have presented as difficult to separate.

Equally important, the processes according to embodiments of the present disclosure are conducted in an inert, environmentally benign and dry environment. This adds value, as fewer waste products need to be addressed and recycling cost can be minimized. The process avoids the use of liquid water, steam or super-heated steam at great environmental advantage. The process also avoids the use of acidic gases, such as carbonic acid or other weak organic acids, or the manufacture of acidic gases in-situ, such as carbon dioxide in an aqueous atmosphere. The presence of these acids increase the complexity of the process, add to the overall cost of the process and increase the environmental foot-print.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

What is claimed is:

1. A method of recycling a lithium-ion battery cell having a lithium-based cathode material deposited on a metallic cathode collector and an anode material deposited on a metallic anode collector, comprising the steps of:
mechanically segmenting the battery cell into a plurality of pieces;
controlled heating of the plurality of pieces in an inert atmosphere;
separating the lithium-based cathode material from the metallic cathode collector; and
separating the cathode collector from the anode collector.

2. The method of claim 1, wherein the plurality of pieces comprise pieces of mixed copper foil coated with a carbon anode material attached immediately adjacent to aluminum foil coated with a lithium cathode material.

3. The method of claim 1, wherein the step of separating the cathode collector from the anode collector occurs after the step of separating the lithium-based cathode material from the metallic cathode collector.

4. The method of claim 1, further comprising the step of controlled cooling of the plurality of pieces after the step of controlled heating.

5. The method of claim 1, wherein the step of separating the cathode collector from the anode collector is performed by an eddy current separator.

6. The method of claim 1, wherein the step of controlled heating of the plurality of pieces in an inert atmosphere is performed by a pyrolysis reactor.

7. The method of claim 6, wherein the step of controlled heating of the plurality of pieces with a pyrolysis reactor comprises heating the pieces to a temperature of less than 660° C.

8. The method of claim 7, wherein the inert atmosphere comprises a dry atmosphere without the presence of water or steam.

9. The method of claim 8, further comprising the steps of, after mechanically segmenting the battery cell into a plurality of pieces and before the controlled heating of the plurality of pieces in an inert atmosphere with a pyrolysis reactor:
heating the plurality of pieces in an oven; and
removing a polymer separator layer from between the cathode collector and the anode collector.

10. The method of claim 9, wherein the step of heating the plurality of pieces in an oven includes heating the pieces to a temperature of approximately 100° C.

11. The method of claim 1, wherein the step of separating the lithium-based cathode material from the metallic cathode collector includes subjecting the plurality of pieces to a vibrating and/or shaking mechanical separation operation.

12. The method of claim 1, further comprising the step of isolating the battery cell from a lithium-ion battery comprising a plurality of battery cells.

13. A system for recycling lithium-ion batteries, comprising:
a cutting device for segmenting a lithium-ion battery cell into pieces;
a heat-generating reactor operating in an inert, dry atmosphere in which the pieces of the cell are heated;
a first separator for removing lithium-based cathode material from a metallic cathode collector of the pieces of the battery cell; and
a second separator for separating the metallic cathode collector from a metallic anode collector after the lithium-based cathode material has been removed from the metallic cathode collector.

14. The system of claim 13, wherein the first separator is a mechanical separator for shaking and/or vibrating the pieces of the battery cell.

15. The system of claim 13, wherein the second separator is an eddy current separator.

16. The system of claim 13, further comprising an oven for heating the pieces of the cell prior to their heating in the heat-generating reactor.

17. The system of claim 16, further comprising an air jet separator for removing a separation material from the metallic collector after heating in the oven.

18. The system of claim 13, further comprising a cooling chamber for cooling the pieces of the cell after they are heated in the heat-generating reactor.
